(19) United States
(12) Patent Application Publication
(10) Pub. No.: US 2009/0052108 A1
(43) Pub. Date: Feb. 26, 2009

(54) Discharge unit for ac ionizer

(75) Inventors: Masayoshi Innami, Tokyo (JP); Masaaki Yamada, Tokyo (JP)

Correspondence Address: BIRCH STEWART KOLASCH & BIRCH, PO BOX 747, FALLS CHURCH, VA, 22040-0747, US

(73) Assignee: HUGLE ELECTRONICS INC., Tokyo (JP)

(21) Appl. No.: 11/918,526

(22) PCT Filed: Jun. 20, 2005
(86) PCT No.: PCT/JP2005/011689

§ 371 Date: Oct. 15, 2007

(51) Int. Cl. H01T 19/04

(52) U.S. Cl. 361/220

(57) ABSTRACT

The present invention relates to a discharge unit for an ac ionizer that supplies positive and negative ions, which are generated by corona discharge by applying an ac high voltage to a discharge needle, by air toward an object to be neutralized. A capacitor (C) includes an electrode piece (12) connected to the discharge needle (3), a dielectric (11a) surrounding the electrode piece (12), and an electrode cylinder (9) substantially in a cup shape surrounding the dielectric (11a), and the ac high voltage is applied to the discharge needle (3) via the capacitor (C). Accordingly, the capacitor (C) can have a capacitance for generating a specified quantity of positive and negative ions.

### TECHNICAL FIELD

The present invention relates to an improved structure of a capacitor for applying a high voltage to discharge needles and an improved air discharge mechanism for supplying positive and negative ions, which are generated by corona discharge by applying an ac high voltage to the discharge needles, to an object to be neutralized, in an ac ionizer that supplies positive and negative ions to the object to be neutralized.

### BACKGROUND ART

As this type of ac ionizer, for example, a “high-tension cable branch device for a static eliminator” disclosed in Patent Document 1 and a “static eliminator” disclosed in Patent Document 2 are known.

FIGS. 9 and 10 depict a discharge unit in the ac ionizer described in Patent Document 1, wherein the whole unit is formed in a bar shape. FIG. 9 is a front elevation of the discharge unit, and FIG. 10 is an X-X cross section in FIG. 9.

In these drawings, reference numeral 101 denotes a high-tension cable, to which an ac high voltage is applied, 102 denotes a connector, 103 denotes a coaxial cable, and 104 denotes a central conductor of the coaxial cable 103. The central conductor 104 is connected to the high-tension cable 101 to form one of electrodes of the capacitor.

Reference numeral 105 denotes a conductive coupling ring as the other electrode of the capacitor, and 106 denotes a discharge needle. The coupling rings 105 are arranged at regular intervals along a longitudinal direction of the coaxial cable 103. 107 and 108 denote molded units, and 109 denotes an earth electrode for forming an electric field between the discharge needle 106 and the earth electrode.

In the above configuration, the central conductor 104 and the discharge needle 106 are capacitively coupled via an insulating coating of the coaxial cable 103. The ac high voltage applied to the central conductor 104 is applied to the discharge needles 106 from the coupling rings 105 via a capacitance of the insulating coating, thereby causing corona discharge between the discharge needles 106 and the earth electrode 109. Accordingly, positive and negative ions are generated around the discharge needles 106.

A discharge unit described in Patent Document 2 has approximately the same configuration as that shown in FIGS. 9 and 10.

### (1) Patent Document 1: Japanese Patent Application Laid-open No. 2002-184595 (Paragraphs [0006] to [0008], FIGS. 1 and 4, etc.)

### (2) Patent Document 2: Japanese Patent Application Laid-open No. 2002-313596 (FIGS. 2 and 7, etc.)

In the conventional art shown in FIGS. 9 and 10, to generate more positive and negative ions from the discharge needles 106 by applying a certain high voltage, the capacitance of the capacitor, which includes the central conductor 104 as one electrode, the coupling rings 105 as the other electrode surrounding the central conductor 104, and the insulating coating lying between the both electrodes, needs to be increased. As a method therefor, it is effective to form the coupling rings 105 long along the axial direction (the interval between the discharge needles 106 becomes long inevitably), thereby to increase the electrode area of the capacitor.

However, when it is desired to reduce the interval between the discharge needles 106 to miniaturize the discharge unit or to increase the static eliminating capability, it is desired to reduce the axial length of the coupling rings 105. In other words, forming the coupling rings 105 long along the axial direction contradicts the demand for reduction of the interval between the discharge needles 106.

That is, from a viewpoint of miniaturization of the discharge unit and improvement of the static eliminating capability, it is desired to increase the capacitance of the capacitor without relying on the method of forming the coupling rings 105 long along the axial direction.

The present invention has been achieved to solve the problem described above, and it is an object of the present invention to provide a discharge unit for the ac ionizer, which enables miniaturization of the discharge unit and improvement of the static eliminating capability, by obtaining a desired capacitance while reducing the interval between the discharge needles.

### DISCLOSURE OF THE INVENTION

To solve the above problem, the present invention provides a discharge unit for an ac ionizer that supplies positive and negative ions, which are generated by corona discharge by applying an ac high voltage to a discharge needle, by air toward an object to be neutralized, wherein a capacitor includes an electrode piece connected to the discharge needle, a dielectric surrounding the electrode piece, and an electrode cylinder substantially in a cup shape surrounding the dielectric, and the ac high voltage is applied to the discharge needle via the capacitor.

Furthermore, according to the present invention, it is desired that an electrode bar having a plurality of electrode cylinders is molded with the dielectric, and the electrode pieces are respectively fixed to face the electrode cylinder via the dielectric to form the capacitor, and each discharge needle fitted to each of detachable discharge needle units in the same number as that of the electrode cylinders is connected to each electrode piece.

Further, according to the present invention, it is desired to form an air discharge hole for discharging the air toward the object to be neutralized on a substrate of the discharge needle unit, and such an air discharge hole is desirably formed in all the discharge needle units or in every other discharge needle unit.

According to the present invention, a plurality of discharge units are connected longitudinally, and the electrode bars in the respective discharge units are connected to each other, thereby to form an ionizer bar having a desired length.

### BRIEF DESCRIPTION OF THE DRAWINGS

FIG. 1 is a plan view of a first embodiment of the present invention;

FIG. 2 is a cross-sectional view along a line II-II in FIG. 1;

FIG. 3 is an enlarged explanatory diagram of relevant parts in FIG. 2;

FIG. 4 is an enlarged cross-sectional view along a line IV-IV in FIG. 2;

FIG. 5 is a plan view of a molded unit in FIGS. 2 and 3;

FIG. 6 is a front elevation of the molded unit in FIGS. 2 and 3;

FIG. 7 is a plan view of a second embodiment of the present invention;

FIG. 8 is a schematic explanatory diagram of a discharge unit used for verifying the operation of the second embodiment of the present invention;

FIG. 9 is a front elevation of a conventional art; and

FIG. 10 is a cross-sectional view along a line X-X in FIG. 9.

### BEST MODES FOR CARRYING OUT THE INVENTION

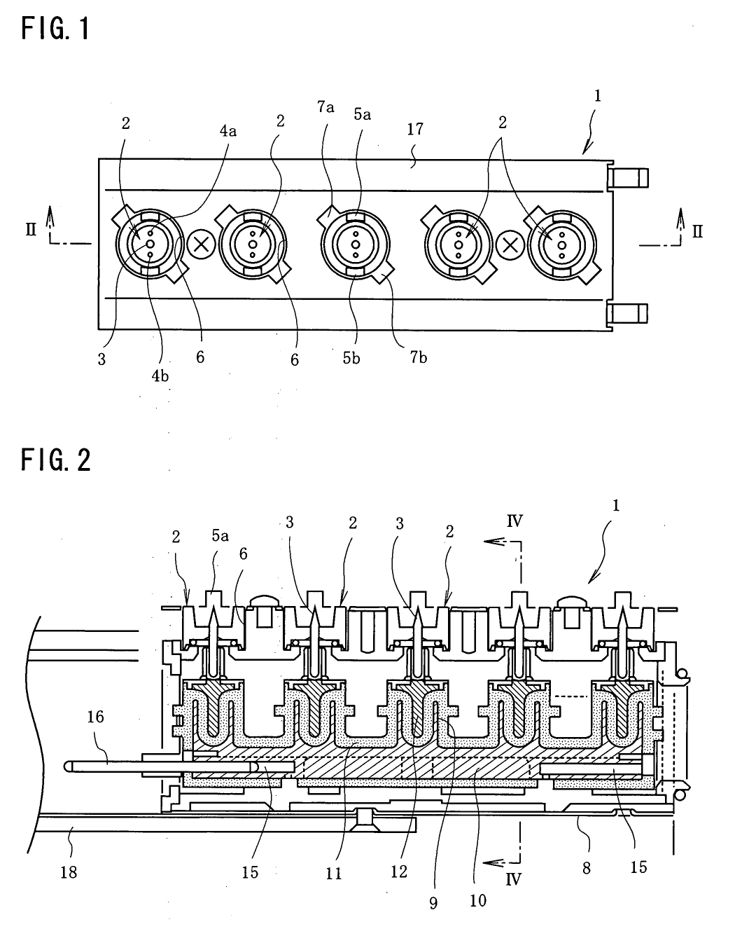

Embodiments of the present invention will be explained below with reference to the drawings. FIG. 1 is a plan view of a first embodiment of the present invention.

In FIG. 1, reference numeral 1 denotes a discharge unit formed in a bar shape, and a discharge needle unit 2 is detachably fitted to each of a plurality of fitting holes 6 (five holes in the case shown in FIG. 1) formed in a longitudinal direction of the discharge unit. The discharge needle unit 2 includes a discharge needle 3 arranged at the center of a substrate 2a and applied with a high ac voltage, and a pair of air discharge holes 4a and 4b formed near the discharge needle 3.

The discharge needle unit 2 includes latch pieces 5a and 5b having elasticity at two positions along a circumferential direction. When the discharge needle unit 2 is rotated around the discharge needle 3, so that these latch pieces 5a and 5b are positioned at notches 7a and 7b on the discharge unit 1, engagement with the fitting hole 6 is released and the discharge needle unit 2 can be detached.

In FIG. 1, reference numeral 17 denotes an earth electrode for forming an electric field with the discharge needle 3.

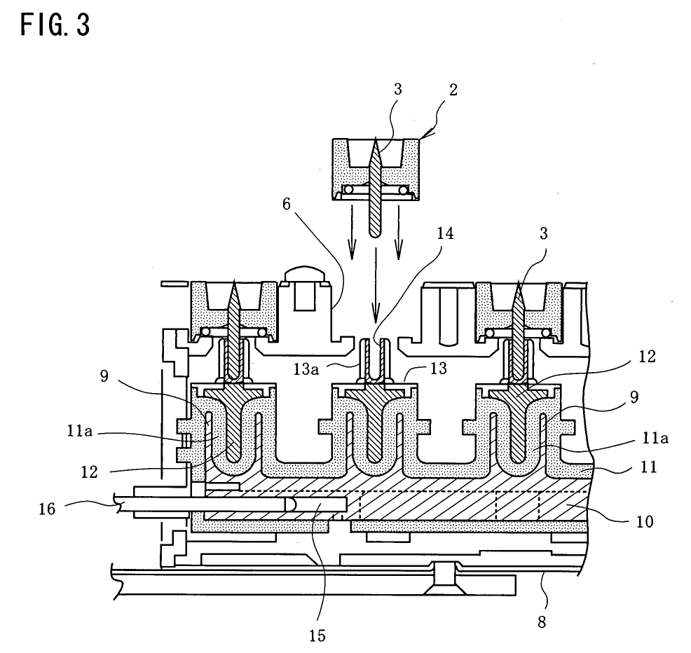

Next, FIG. 2 is a cross-sectional view along a line II-II in FIGS. 1 and FIG. 3 enlargedly shows relevant parts in FIG. 2. In FIG. 3, one of the discharge needle units 2 is detached and the latch pieces 5a and 5b are not shown for convenience’ sake.

The internal structure of the discharge unit 1 is explained first with reference to FIGS. 2 and 3.

Inside a cover 8, a mold 11 made of synthetic resin, which surrounds the whole electrode bar 10 having five electrode cylinders 9 in a cup shape with an elliptic cross section, and substantially flat electrode pieces 12 facing the electrode cylinder 9 via a dielectric 11a made of synthetic resin inside the electrode cylinder 9 and constituting the capacitor together with the electrode cylinder 9 are arranged.

As shown in FIG. 3 in detail, a hood 13 having a substantially T-shape is fixed on each electrode piece 12, and a conductive discharge-needle holding unit 14, which is electrically connected to the electrode piece 12, is fitted to the inside of a cylinder 13a of the hood 13.

According to this configuration, in a state with the discharge needle unit 2 being fitted in the fitting hole 6, the discharge needle 3 is electrically connected to the electrode piece 12 via the discharge-needle holding unit 14. Accordingly, the high ac voltage can be applied to the discharge needle 3 via a capacitor C, in which the electrode cylinder 9 of the electrode bar 10 forms one electrode thereof and the electrode piece 12 forms the other electrode, and the dielectric 11a is put therebetween.

A blind hole 15 is formed on the opposite sides at the bottom of the electrode bar 10, and the electrode bar 10 in another discharge unit 1 adjacent thereto can be sequentially connected, using a conductive pin 16 inserted into the blind hole 15. Accordingly, by applying the ac high voltage from a high-voltage power supply circuit to the electrode bar 10 or the conductive pin 16 at the end, power can be fed to the plural discharge units 1 connected with each other. Corona discharge occurs due to application of the high voltage between each discharge needle 3 fitted in the fitting hole 6 and the earth electrode 17.

In FIG. 2, reference numeral 18 denotes a metal casing, and the discharge unit 1 can be held by the casing 18 in a state in which a plurality of discharge units 1 (for example, four) are connected with each other in the longitudinal direction.

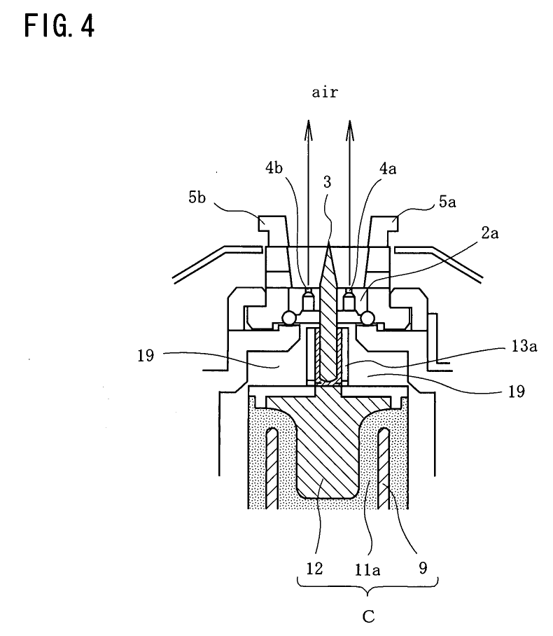

FIG. 4 is an enlarged cross-sectional view along a line IV-IV in FIG. 2. In FIG. 4, reference numeral 19 denotes an air passage connecting to an air supply source such as an external compressor, which leads to the air discharge holes 4a and 4b. With this configuration, the air supplied to the air passage 19 is discharged forward of the discharge needle 3 via the air discharge holes 4a and 4b so that positive and negative ions generated around the discharge needle 3 can be discharged toward the object to be neutralized.

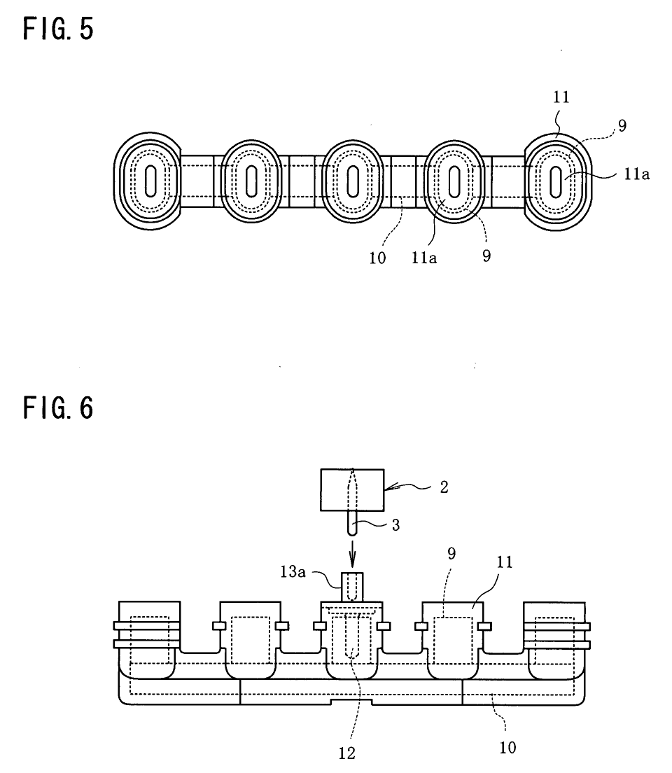

FIGS. 5 and 6 show externals of the mold 11 having the electrode bar 10 in FIG. 2 built therein, and the discharge needle unit 2 mounted thereon via the electrode piece 9 and the cylinder 13a is additionally shown at the center in FIG. 6.

As is apparent from the above explanations, in the embodiment, the capacitor C for applying the ac high voltage to the discharge needle 3 includes the substantially flat electrode piece 12 electrically connected to the discharge needle 3, the dielectric 11a that surrounds the electrode piece 12, and the electrode cylinder 9 in the cup shape that surrounds the dielectric 11a. The electrode piece 12 and the electrode cylinder 9 constitute the two electrodes of the capacitor C, and the whole inner surface of the electrode cylinder 9 can be used as a surface area of the electrode, which contributes to an increase of the capacitance of the capacitor C.

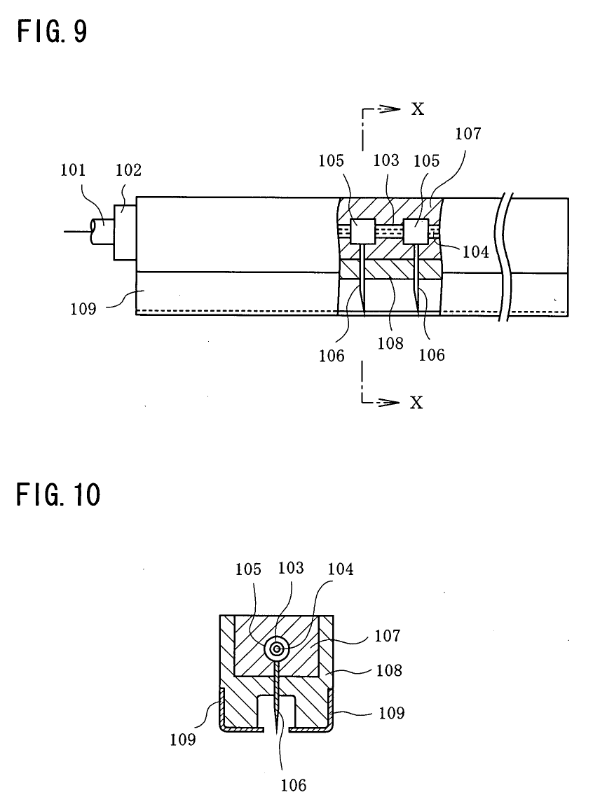

Accordingly, even when the electrode bar 10 is formed by making the interval between the adjacent electrode cylinders 9 as short as possible and the discharge needles 3 corresponding to the respective electrode cylinders 9 are arranged close to each other, the capacitor C can have the desired capacitance to obtain the desired positive and negative ion amount. That is, the amount of ions to be generated can be increased without adopting a method of extending the coupling rings 105 in the axial direction to increase the capacitance of the capacitor as in the conventional art shown in FIG. 9.

Accordingly, the length of the discharge unit 1 can be reduced, thereby enabling miniaturization and lightening of the entire ionizer. The static eliminating capability can be also improved by reducing the interval between the discharge needles 3.

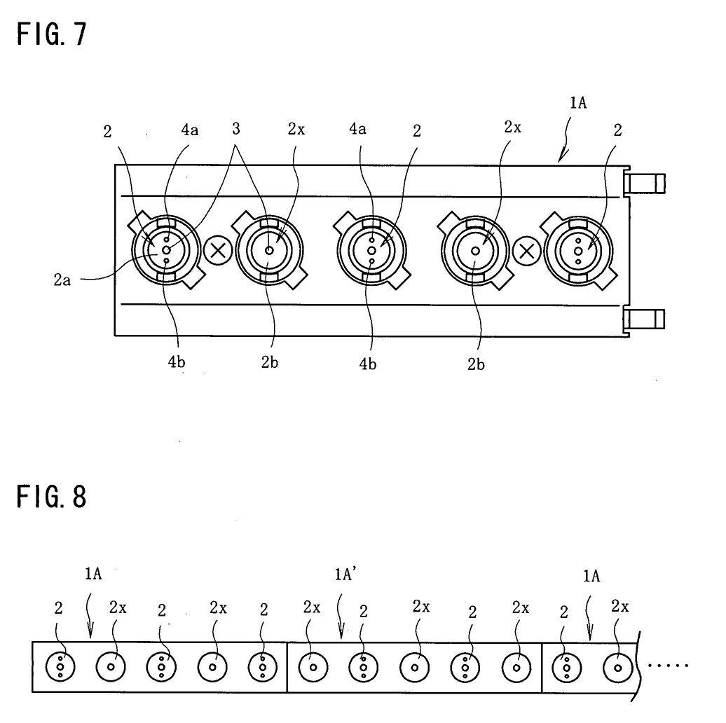

Next, FIG. 7 is a plan view of a second embodiment of the present invention. An internal structure of a discharge unit 1A according to the second embodiment is the same as that of the first embodiment shown in FIGS. 2 to 6. That is, the structure of the capacitor C for applying the ac high voltage to the discharge needle 3 is the same as that shown in FIG. 3 and the like, but the structure of the discharge needle unit is different.

In the second embodiment, as shown in FIG. 7, the discharge needle units 2 the same as that of the first embodiment and discharge needle units 2x without having the air discharge holes 4a and 4b on a substrate 2b are alternately arranged. The discharge needle unit 2x includes the substrate 2b, which does not have the air discharge holes 4a and 4b originally, however, the discharge needle unit 2 having the air discharge holes 4a and 4b can be used by filling up the air discharge holes 4a and 4b with an adhesive or the like.

As described above, when the discharge needle unit 2 having the air discharge holes 4a and 4b and the discharge needle unit 2x without the air discharge holes 4a and 4b are alternately arranged to supply the air from the air supply source, flow velocity of the air discharged from the air discharge holes 4a and 4b of the alternate discharge needle unit 2 can be increased, as compared with the first embodiment, even when the flow rate of the air is reduced to some extent. Accordingly, the positive and negative ions generated around the discharge needles 3 of the discharge needle units 2x without the air discharge holes 4a and 4b can be drawn into the flow of the air discharged from the adjacent discharge needle units 2, and supplied toward the object to be neutralized.

The present inventor measured an ion balance of the generated positive and negative ions and the time required to neutralize the surface of the object to be neutralized to verify the operation, using a sample (sample A) obtained by connecting five of the discharge units 1 in FIG. 1 and a sample (sample B) obtained by alternately connecting discharge units 1A and 1A′ five in total as shown in FIG. 8, in which the discharge needle units 2 and 2x are arranged alternately.

As the neutralization time, the time until charge potential on the surface of the object to be neutralized reached +100 [V] from +1 [kV] was measured as the neutralization time on+side, and the time until the charge potential reached −100 [V] from −1 [kV] was measured as the neutralization time on−side. A distance from the discharge needle 3 to the surface of the object to be neutralized was set to 900 [mm], and a pressure of the air to be discharged from the air discharge holes 4a and 4b was set to a constant value of 0.2 [Mp] by an air regulator.

As a result, in the sample A, the neutralization time on+side was 2.0 [sec], and on−side 2.1 [sec] by discharging air of 92 [L/min], while in the sample B, the neutralization time on+side was reduced to 1.6 [sec], and the neutralization time on−side was reduced to 1.9 [sec] by discharging only air of 64 [L/min]. It was also confirmed that the ion balance was improved in the sample B than in the sample A.

The above result indicates that the sample B to which the second embodiment is applied can remove electricity in a shorter period of time with less air flow rate than in the first embodiment. Even when the discharge needle unit 2 having the air discharge holes 4a and 4b and the discharge needle unit 2x without the air discharge holes 4a and 4b are alternately arranged as in the second embodiment, the air flow rate can be reduced without damaging the static eliminating performance.

Accordingly, cost reduction and energy saving can be achieved by reducing the capacity, capability, and power consumption of the compressor or the like as the air supply source, and an adverse effect to the environment can be also reduced.

Note that, in the discharge unit having the conventional structure as shown in FIG. 10, a ground member may be fitted to cover the circumference of the molds 107 and 108 at the time of actual use. In this case, the high voltage applied to the central body 104 is divided and also distributed to the capacitor including the coupling rings 105, the molds 107 and 108, and the ground member, and the static eliminating performance may be decreased due to a decrease of the voltage applied to the discharge needles 106.

According to the present invention, however, the electrode piece 12 electrically connected to the discharge needle 3 is surrounded by the electrode cylinder 9, and the high voltage applied to the electrode cylinder 9 is directly applied to the discharge needle 3 due to capacitor coupling. Accordingly, the applied voltage to the discharge needle 3 does not decrease due to the voltage division as in the conventional technology. Because the metal casing 18 is grounded, there is no influence resulting from the surrounding structure of the discharge needle 3.

1. A discharge unit for an ac ionizer that supplies positive and negative ions, which are generated by corona discharge by applying an ac high voltage to a discharge needle, by air toward an object to be neutralized, wherein
a capacitor comprises an electrode piece connected to the discharge needle, a dielectric surrounding the electrode piece, and an electrode cylinder substantially in a cup shape surrounding the dielectric, and
the ac high voltage is applied to the discharge needle via the capacitor.

2. The discharge unit for an ac ionizer according to claim 1, wherein an electrode bar having a plurality of the electrode cylinders is molded with the dielectric, and each of the electrode pieces is fixed to face the electrode cylinder via the dielectric to form the capacitor, and each of the discharge needles fitted to each of detachable discharge needle units in the same number as that of the electrode cylinders is connected to each electrode piece.

3. The discharge unit for an ac ionizer according to claim 1 or 2, wherein an air discharge hole for discharging the air toward the object to be neutralized is formed on a substrate of the discharge needle unit.

4. The discharge unit for an ac ionizer according to claim 1 or 2, wherein an air discharge hole for discharging the air toward the object to be neutralized is formed in all the discharge needle units.

5. The discharge unit for an ac ionizer according to claim 1 or 2, wherein a discharge needle unit in which an air discharge hole for discharging the air toward the object to be neutralized is formed on a substrate and a discharge needle unit having no air discharge hole are alternately arranged along a longitudinal direction.

6. The discharge unit for an ac ionizer according to claim 2, wherein a plurality of the discharge units are connected longitudinally, and the electrode bars in the respective discharge units are connected to each other.
